(19) United States
(12) Patent Application Publication
(10) Pub. No.: US 2014/0109208 A1
(43) Pub. Date: Apr. 17, 2014

(54) METHOD AND SYSTEM FOR IMAGE-BASED USER AUTHENTICATION

(71) Applicant: Jesse Song, Edison, NJ (US)

(72) Inventor: Jesse Song, Edison, NJ (US)

(21) Appl. No.: 13/650,472

(22) Filed: Oct. 12, 2012

(51) Int. Cl. G06F 21/31

(52) U.S. Cl. CPC G06F 21/31
USPC 726/7

(57) ABSTRACT

A system and method which authenticates a suspect user of a service by use of images of an authentication object. A registered user provides a trusted image depicting an authentication object, said image being then stored as a master image. Later attempts to access the service then require providing an additional image of the authentication object, the object in the additional image being compared to that in the master image and access being granted if the two images are found to depict the same object.

### BACKGROUND OF THE INVENTION

1. Field of the Invention

Aspects of the present invention include a method and system of user authentication using images of an authentication object.

2. Description of the Related Art

In this modern age, where the Internet and computer-based services have become a vast part of our culture, it is difficult to create an authentication that is both secure and convenient to the user. Currently, to access most computer services, the user must submit an alphanumeric password for authentication. The alphanumeric password system only works well if the user creates a lengthy, random, and unique password for each service he uses. But using this system effectively is very difficult for the user, because it is difficult to create passwords that are both complex and easy to remember. Therefore, many users “cheat” by using easier and less secure passwords. Doing this creates vulnerability in the user authentication system.

Some users merely create short passwords consisting purely of dictionary words or other lower-case letter combinations. When the system is used improperly in this manner, the alphanumeric system can be hacked through birthday attacks and brute force. Many services therefore require more complicated passwords, but this additional complexity encourages other improper uses of the system.

Many users create passwords based on their personal information. Although incorporating users' personal information into a password makes it easier to remember, it also makes the password far less secure. Examples of personal information commonly used are phone numbers, family names, school names, car models, pet names, important dates and places, etc. All of these can be found on the Internet with enough searching. Because of this, people close to the user as well as people capable of Internet sleuthing can potentially compromise the user's account.

With the millions of services one can subscribe to on the Internet these days, it is not uncommon for a single person to be a user for more than a hundred different services. Therefore, another way users can “cheat” and compromise a system's security is by using a single master password for many or all of their accounts, or, to a lesser extreme, a set of very similar passwords. If a single one of those services or accounts is compromised, whether through hacking, spoofing, guesswork, or other methods, the user must immediately change all passwords that are the same or similar to the one compromised.

Similarly, if it becomes necessary to share a password with someone, whether because it's a shared account or because the user is temporarily giving access to an acquaintance, the recipient can possibly figure out patterns in the passwords and gain access to the user's other accounts as well.

On the other hand, if users use the alphanumeric system properly, they must keep track of numerous lengthy, unique, and difficult-to-remember passwords. Moreover, users must change passwords periodically to truly secure a system. Managing all of these passwords is very difficult and chaotic. As time passes, many users forget their passwords, in particular seldom-used ones.

To protect against forgotten passwords, many systems include a recovery process. However, the current standard password recovery process, where a user answers personal questions in order to recover his password, is inconvenient and easily compromised. In order to remember the answers to their questions, many users choose questions with a single and definitive answer such as “Which city were you born in?” as opposed to subjective questions such as “What is your favorite hobby?” Questions with a single and definitive answer can often be found through Internet searching or by questioning people close to the user.

Another problem with the current password recovery process is that they all rely on the user's email address, creating a potential single point of failure. If a user's email account is compromised, the hacker will have the means of obtaining account information for all services that used that email address for registration.

In a worst case scenario where a hacker gains access to a user's account as well as the email account linked to it, the hacker can potentially change all login credentials and password recovery answers, making it impossible for a user to recover his account. The user would be forced to contact customer service in order to resolve the issue, an extremely inconvenient solution.

### SUMMARY OF THE INVENTION

While not limited thereto, an embodiment of the invention includes a method for authenticating a user of a service, the method comprising creating a digital image of a suspect object, the suspect object not being a body part of the user; transmitting the digital image to an authentication device for comparison with a master image, the master image having been previously stored on the authentication device and being of a master object, the master object not being a body part of the user; when the authentication device determines that the suspect object in the digital image matches the master object in the master image, receiving access to the service; and when the authentication device determines that the suspect object in the digital image does not match the master object in the master image, being denied access to the service.

According to an aspect of the invention, the method may also comprise, prior to creating the digital image of the suspect object, creating a second digital image of an authentication object, the object not being a body part of the user; and transmitting the second digital image to the authentication device to serve as the master image.

According to an aspect of the invention, the method may also comprise creating a third digital image of a image of a second authentication object, the object not being a body part of the user; and transmitting the third digital image to the authentication device to serve as a replacement of the master image.

According to an aspect of the invention, the method may also comprise, prior to transmitting the digital image, associating an outline that surrounds the suspect object with the digital image.

According to an aspect of the invention, the method may also comprise, prior to transmitting the second digital image, associating an outline that surrounds the authentication object with the second digital image.

According to an aspect of the invention, the method may also comprise, prior to transmitting the third digital image, associating an outline that surrounds the second authentication object with the third digital image.

According to an aspect of the invention, the method may also comprise, prior to creating the digital image of the suspect object, receiving the outline associated with the second digital image.

According to an aspect of the invention, the method may also comprise, after creating the second digital image of the authentication object, transmitting a text description of the second digital image to the authentication device.

According to an aspect of the invention, the method may also comprise, before creating the digital image of the suspect object, receiving the text description.

According to an aspect of the invention, one or more of the digital images may be created by a digital camera.

According to an aspect of the invention, the digital camera may be a cell phone camera.

According to an aspect of the invention, the digital camera may be a digital camera with a mobile operating system.

According to an aspect of the invention, the digital camera may be a web camera.

According to an aspect of the invention, the digital camera may have a mobile operating system.

According to an aspect of the invention, one or more of the digital images may be created by a scanner.

According to an aspect of the invention, one or more of the objects may comprise a physical object.

According to an aspect of the invention, one or more of the physical objects may comprise a handwritten message.

According to an aspect of the invention, one or more of the handwritten messages may be surrounded by an outline.

According to an aspect of the invention, one or more of the physical objects may comprise printed material surrounded by an outline.

According to an aspect of the invention, one or more of the physical objects may comprise a three-dimensional object.

According to an aspect of the invention, one or more of the objects may comprise a digital object.

While not limited thereto, another embodiment of the invention is directed to a method for authenticating a user of a service, the method comprising receiving a digital image of a suspect object into an authentication device, the object not being a body part of the user; comparing the digital image with a master image, the master image having been previously stored on the authentication device and being of a master object, the master object not being a body part of the user; when the authentication device determines that the suspect object in the digital image matches the master object in the master image, granting access to the service; and when the authentication device determines that the suspect object in the digital image does not match the master object in the master image, denying access to the service.

According to an aspect of the invention, the method may also comprise, prior to receiving the digital image of the suspect object, receiving a second digital image of an authentication object into the authentication device, the object not being a body part of the user; and storing the second digital image in a memory of the authentication device to serve as the master image.

According to an aspect of the invention, comparing the digital image with the master image may comprise comparing an outline associated with the digital image with an outline associated with the master image, and reconstructing both the digital image and the outline in the same manner such that the outline associated with the digital image matches the outline associated with the master image.

According to an aspect of the invention, the method may also comprise, prior to comparing the digital image with the master image, associating an outline that surrounds the suspect object with the digital image.

According to an aspect of the invention, the method may also comprise, prior to storing the second digital image, associating an outline that surrounds the authentication object with the second digital image.

According to an aspect of the invention, any of the above methods may be encoded on a computer readable medium as processing instructions for implementing the method using one or more processors.

While not limited thereto, another embodiment of the invention is directed to a system for authenticating a user of a service, the system comprising a memory which stores a trusted digital image of an object, the object not being a body part of the user, as a master image for an authentic user of the service within the memory, receives a request by an unauthenticated user to authenticate as said authentic user using a suspect digital image sent from the user, when the object in the suspect image matches the object in the master image, allowing access to the service as the authentic user, and when the object in the suspect image does not match the object in the master image, denying access to the service.

According to an aspect of the invention, the processor may also store a second trusted digital image of an object, the object not being a body part of the user, as a replacement of the master image for an authentic user of the service within the memory.

According to an aspect of the invention, the memory may comprise a database storing multiple digital images and user data.

According to an aspect of the invention, the system may further comprise a transceiver through which the request by an unauthenticated user is received.

According to an aspect of the invention, the system may further comprise a user device which creates the request by an unauthenticated user.

According to an aspect of the invention, the system may further a digital camera which produces and/or provides the trusted digital image and/or the suspect digital image and provides it to the processor.

According to an aspect of the invention, the processor may also associate an outline with the trusted digital image and/or the suspect digital image, said outline surrounding the object in said digital image.

According to another aspect of the invention, the user device may also associate an outline with the trusted digital image and/or the suspect digital image, said outline surrounding the object in said digital image.

According to another aspect of the invention, the digital camera may also associate an outline with the trusted digital image and/or the suspect digital image, said outline surrounding the object in said digital image.

According to an aspect of the invention, the processor may also, after receiving a request by an unauthenticated user to authenticate, compare an outline associated with the suspect digital image with an outline associated with the master image, and reconstruct the suspect digital image such that the outline associated with the suspect digital image is aligned with the outline associated with the master image.

According to an aspect of the invention, the processor may reconstruct the suspect digital image using a turning point mapping algorithm such that turning points and line segments of the suspect digital image are made to match those of the master image.

According to an aspect of the invention, the processor may also, before storing the digital image in the database, further recompose one or more features of the digital image.

According to an aspect of the invention, one feature recomposed may be a size of the digital image.

According to an aspect of the invention, one or more of the objects may comprise a physical object.

According to an aspect of the invention, one or more of the physical objects may comprise a handwritten message.

According to an aspect of the invention, one or more of the handwritten messages may be surrounded by an outline.

According to an aspect of the invention, one or more of the physical objects may comprise printed material surrounded by an outline.

According to an aspect of the invention, one or more of the physical objects may comprise a three-dimensional object.

According to an aspect of the invention, one or more of the objects may comprise a digital object.

According to an aspect of the invention, the processor may also process the service accessed by the authentic user.

According to an aspect of the invention, the transceiver may also provide access of the service to the authentic user.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a system for registering and authenticating images according to an aspect of the invention.

FIG. 2 is a master image registration process according to an aspect of the invention.

FIG. 3 is a suspect image authentication process and forgot password process according to an aspect of the invention.

FIG. 4A is a black and white photograph of an exemplary authentication object according to one aspect of the invention, using an ornamental magnet.

FIG. 4B is an outline of the authentication object of FIG. 4A according to one aspect of the invention.

FIG. 4C is the outline of 4B processed using turning points mapping according to an aspect of the invention.

FIG. 4D is an outline of an exemplary suspect object, believed to be the same as the authentication object of FIG. 4A but taken from a different distance and angle, and processed using turning points mapping according to an aspect of the invention

FIGS. 5A and 5B are black and white photographs of additional exemplary authentication objects according to various aspects of the invention. Specifically, FIG. 5A depicts use of handwritten text and a handwritten semi-rectangular outline on a post-it note, while FIG. 5B depicts use of printed text and a handwritten semi-rectangular outline in a document page.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

According to an aspect of the invention, a user may be granted access to a service by submitting an image of an authentication object. Since the user needs the authentication object present to access the service, the user may apply the concept of physical security to computer security. Physical security measures such as safes and security guards may be applied to the digital world. As long as the object is secured, the authenticating service is also secured.

The term “service” is used throughout the application to describe a benefit that requires authentication or a “key” to access, and “user” is used to describe the person seeking such access. The application largely speaks of such services in terms of a software-based service. However, it will be appreciated by those skilled in the art that such “services” to which access might be desired can include hardware devices such as physical computers or mobile devices, non-computer accounts such as bank accounts, or even physical locations, all of which often require authentication or “keys” before user access is granted.

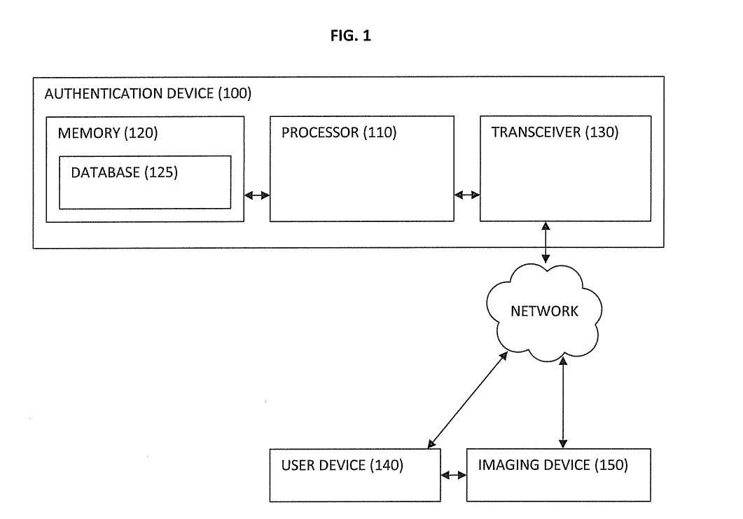

According to an aspect of the invention depicted in FIG. 1, an authentication device 100 comprises a processor 110 and memory 120. While not required in all aspects, the memory 120 comprises a database 125.

In the shown embodiment, the processor 110 receives requests through a transceiver 130 from one or more user devices 140 across a network. However, it is understood that the user device 140 may be merely an interface also processed by the processor 110 and thus be directly connected via wired or wireless connections. Further, the user device 140 may be the same device as the authentication device 100.

An imaging device 150 produces images, which the processor 110 receives and stores in the memory 120 across the network. In various embodiments, the imaging device 150 may be part or all of the user device 140, such as a cell phone with a camera, part or all of the authentication device 100, such as a security device with a camera, or separate from both yet sending images through the transceiver 130 via the network. In some embodiments, the imaging device 150 may include its own software, such as an operating system, which may participate in any part of the processes described below. It will be appreciated by those skilled in the art that other combinations are also possible.

The imaging device 150 is not limited and may be appreciated by those skilled in the art, but can include digital cameras, including cell phone cameras and web cameras, and scanners in or out of combination with non-digital cameras. Further, the invention is not limited to visible light wavelengths, and thus the imaging device 150 could also be an infrared or radiation detector, or other detector of nonvisible elements.

The transceiver 130 is not limited and may be appreciated by those skilled in the art, but can include hardware capable of interacting with wired and wireless networks, mobile phone networks, Bluetooth transmissions, or the Internet, or a USB connector or other data port. In cases where both the user device 140 and the imaging device 150 are part of the authentication device 100, the transceiver 130 may also be an internal hub.

1. Registering the Master Authentication Image

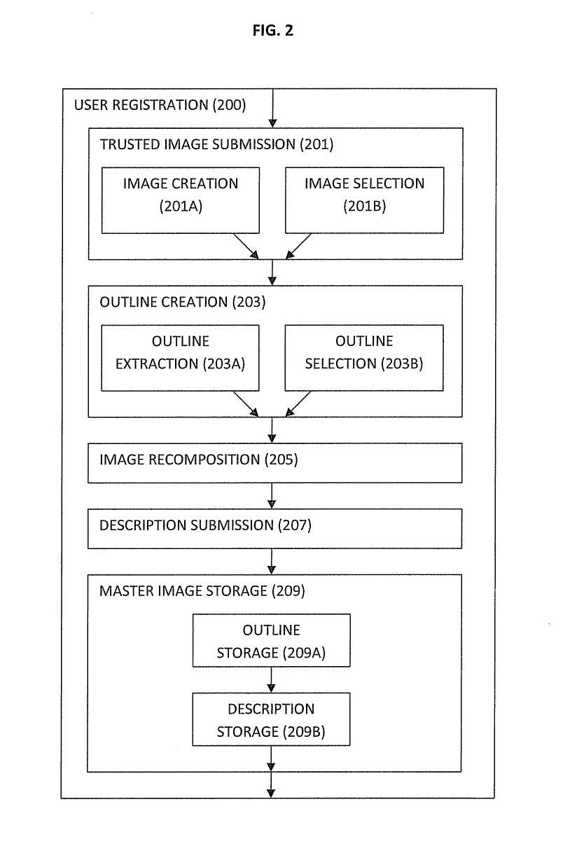

According to an aspect of the invention depicted in FIG. 2, during a user registration process 200, a trusted image is submitted 201 to the processor 110 and stored 209 as a master authentication image in the memory 120.

The image may be created at the time of submission, as is the case in option 201A. This image may, in some embodiments, be created using the imaging device 150. In some embodiments, the processor 110 will create an interface that aids in creating and submitting the image. Such an interface may in some embodiments place an outline on top of the image to aid the user. In some embodiments, where the imaging device 150 is connected to the processor 110 through the Internet, the processor 110 will send the imaging device 150 a message comprising a URL that describes the Internet location of an image outline, which the user may download to aid in the image creation, and the Internet location of the submitted image to be uploaded.

As an alternative, the submitted image may be a previously created image, as is the case in option 201B. This image may, in some embodiments, be stored on a user device 140. The stored image can be created and saved to the memory 120 for the purpose of the registration, and deleted from the user device 140 immediately after for security reasons. In other embodiments, the stored image may remain on the user device 140 for later resubmission as a suspect comparison image.

The methods used to create an interface between the processor 110 and the user device 140 or imaging device 150 may include but are not limited to firmware, installed software, web applications, or mobile phone applications.

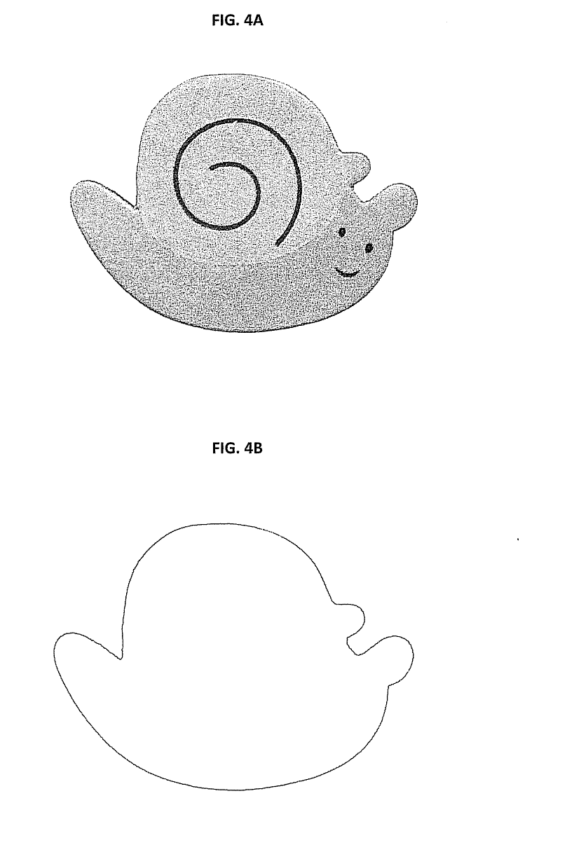

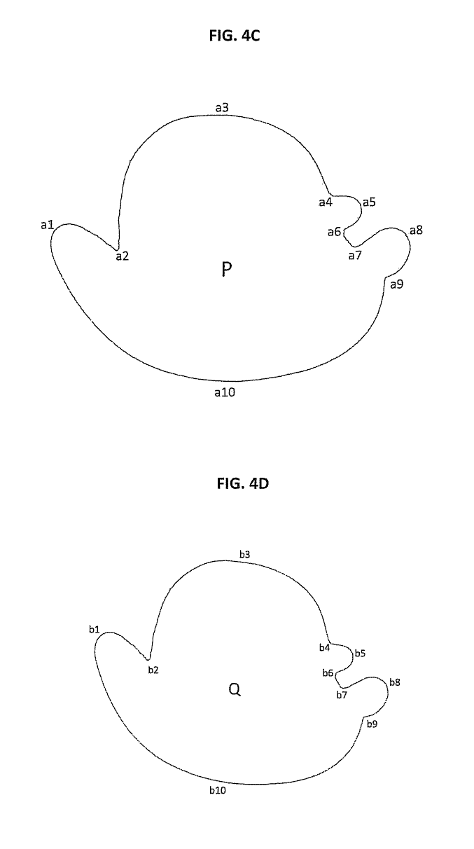

In the shown embodiment, when registering a user's master authentication image, the processor 110 also creates 203 an outline of the object in the image, which will be stored 209A in association with the master image in memory 120. Two examples of such an outline is depicted in FIGS. 4A and 4B. FIG. 4A depicts an object, which may be an authentication object, and in the shown embodiment is a three-dimensional ornamental magnet. FIG. 4B depicts an outline as might be created from and associated with the object of FIG. 4A.

The user may then, during the authentication process described below, be provided with the outline of the object, and may use the outline as an overlay to align the object and minimize margin of error in creation of a suspect comparison image. Depending on the distinctness of the outline, it may in some embodiments also serve as a reminder to the user of the identity of the authentication object. This outline may further, in some embodiments, be used to guide the later authentication, described below. Such an outline may be optional or mandatory depending on the embodiment. In the shown embodiment, the processor 110 may extract the outline itself, as shown in option 203A, or the user may supply it, as shown in option 203B, although in other embodiments only one or the other may be possible. It is possible that a device other than the processor 110, such as the user device 140 or the imaging device 150, might extract 203A the outline; in such cases the outline creation 203 may occur before the image submission 201. Also, it will be recognized by those skilled in the art that the outline creation might occur at other points in the process without decreasing the functionality of the method as a whole. The outline is not required in all aspects, such that operations 203 and 209A are both optional.

In some embodiments where the authentication object is on a flat surface, a real-world outline, including but not limited to simple shapes such as a circle or rectangle, may be added to the object itself in advance. It is also understood that the outline need not be solid, but could also be a series of reference points and/or non-linear or curvilinear elements.

In the shown embodiment, the processor 110 recomposes 205 the master image into a smaller file of a predetermined size. This predetermined size may in some embodiments be defined by pixel size, file size, or resolution, among other options. The smaller image may reduce the storage space in memory 120 required for registering master images. The smaller image may also make the authentication described below more efficient by reducing the size of images to compare, and more reliable by introducing additional consistency between submitted images. However, it is understood that operation 205 could involve enlarging the image or portions thereof, or any other recomposition of the image features into a form more helpful to the overall processes. As one of many possible examples, the image could be converted from one image format, such as a JPEG, into another image format, such as a BMP. It is possible that a device other than the processor 110, such as the user device 140 or the imaging device 150, might recompose 205 the outline; in such cases the recomposition 205 may occur before the image submission 201. Also, it will be recognized by those skilled in the art that the recomposition might occur at other points in the process without decreasing the functionality of the method as a whole.

In the shown embodiment, during registration, the user is also asked to submit 207 a brief description of the object in the master image, which will be stored 209B in association with the master image in memory 120. The user may then, during the authentication described below, be provided with the brief description. This description may help the user remember which object was used for authentication. This description may be extremely detailed without necessarily compromising the security of the system, as a hacker may learn what the authentication object is, but nonetheless cannot gain access if the object is unique to the user and in the user's possession. Although the embodiment in FIG. 2 depicts this step as occurring at the end of the process, it will be recognized by those skilled in the art that the description might be provided at other points in the process without decreasing the functionality of the method as a whole. However, the description is not required in all aspects, such that operations 207 and 209B are both optional.

If maximum security is desired, the user should not separately store any images of the object after submitting the master image. By not storing an image after registration or authentication, the service's security will match the object's physical security; an unstored image cannot be leaked. However, in situations where high security is not as vital, the user may store an image file of the object and can therefore authenticate much more conveniently. In some embodiments, the user also has the option of submitting a digital object—that is, an image generated purely by computer rather than from a photograph of a real-world object. Such an object will also make it more convenient for the user to authenticate.

2. Authenticating the Suspect Comparison Image

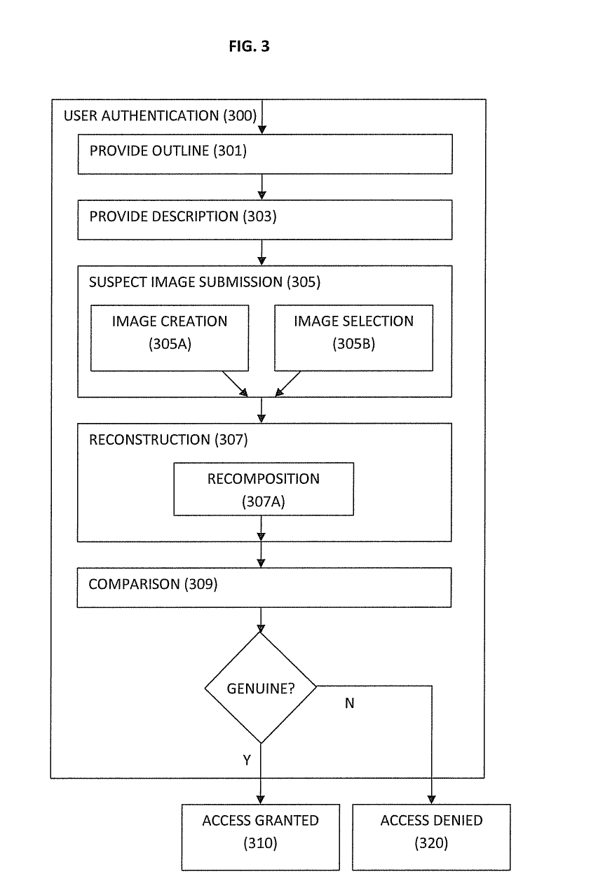

According to an aspect of the invention depicted in FIG. 3, to authenticate 300 a user and grant access 310 to a service, a suspect image is submitted 305 to the processor 110. The submitted suspect image will then be compared 309 to the master image in memory 120 to determine whether or not the submitted image is genuine—that is, of the same object. If the image is genuine, the user is granted access 310 to the service; otherwise, the user is refused access 320.

While not required in all aspects, where an outline was created 203 as part of the master image registration, said outline may be provided 301 before the suspect image is submitted 305. While also not required in all aspects, where a description was submitted 207 as part of the master image registration, said description may be provided 303 before the suspect image is submitted 305. It will be recognized by those skilled in the art that these two features, if both included, may occur in either order without decreasing the functionality of the method as a whole.

The image may be created at the time of submission, as is the case in option 305A. In the shown embodiment, this image is created using the imaging device 150. In some embodiments, the processor 110 creates an interface that aids in creating and submitting the image. Such an interface may supply an outline, often but not necessarily the outline provided at 301, to aid the user in creating the image in a manner that will better match the master image. In some embodiments, where the imaging device 150 is connected to the processor 110 through a network, the processor 110 will send the imaging device 150 a message comprising a network address or URL that describes the location of an image outline, which the user may download to aid in the image creation, and the Internet location of the submitted image to be uploaded.

As an alternative, the submitted image may be a previously created image, as is the case in option 305B. This image may, in some embodiments, be stored on a user device 140 or imaging device 150. Although the stored image is ideally created and saved to the memory 120 the purpose of the registration, and deleted from the user device 140 and/or imaging device 150 immediately after for security reasons, in some embodiments the stored image may remain on the user device 140 or imaging device 150 for later resubmission as a suspect comparison image.

Although not in the embodiment shown in FIG. 3, after image submission 305, the processor 110 may create an outline of the object in the image. One example of such an outline is depicted in FIGS. 4A and 4B. FIG. 4A depicts an object, which may be a suspect object, and is in the shown embodiment a three-dimensional ornamental magnet. FIG. 4B depicts an outline as might be created from and associated with the object of FIG. 4A. The processor 110 may extract the outline itself, or the user may supply it, or either option might be allowed based on user preference. It is possible that a device other than the processor 110, such as the user device 140 or the imaging device 150, might extract the outline; in such cases the outline creation may occur before or as part of the image submission 305. Also, it will be recognized by those skilled in the art that the outline creation might occur at other points in the process without decreasing the functionality of the method as a whole.

In some embodiments where the authentication object is on a flat surface, a real-world outline, including but not limited to simple shapes such as a circle or rectangle, may be added to the object itself in advance. It is also understood that the outline need not be solid, but could also be a series of reference points and/or non-linear or curvilinear elements.

The methods used to create an interface between the processor 110 and the user device 140 or imaging device 150 may include but are not limited to firmware, installed software, web applications, or mobile phone applications.

While not required in all aspects, in the shown embodiment, the processor 110 first reconstructs 307 the suspect image before comparing 309 it to the master image in storage 120. In order to compensate for the small differences due to factors such as brightness, position, angles, and distortion due to the camera's position, the reconstruction 307 reconstructs the submitted image to more accurately match the master image, based on these factors. It is possible that a device other than the processor 110, such as the user device 140 or the imaging device 150, might reconstruct 307 the suspect image; in such cases the reconstruction 307 may occur before the image submission 305.

While not limited thereto, the reconstruction algorithm 307 may include comparing an outline associated with the suspect image to an outline associated with the master image. The reconstruction 307 then includes reorienting or otherwise rearranging both the suspect image and its associated outline in the same manner, such that said outline matches the outline associated with the master image. The outline associated with the master image may have been extracted 203A or selected 203B by the authenticated user during registration 200.

In combination with or apart from the outline comparison, the reconstruction algorithm 307 may include a turning points mapping method. An example of the use of this method is depicted in FIGS. 4C and 4D, using the object of FIG. 4A and the outline of FIG. 4B. A turning point is defined as a point that lies on the object's edge and whose slope changes according to the requirements of the embodiment. In various embodiments, the required slope change may be up-to-down or left-to-right, or any change of more than 90 degrees as compared to the last turning point; it will be appreciated by those skilled in the art that still other changes in slope or direction may also define a turning point.

In the master image P, depicted in FIG. 4C, the turning points a1 through a10 are identified, the line segments formed by adjacent turning points are calculated, and the lengths and angles of each line segment are recorded. These same turning points b1 through b10 and line segments are then located on the suspect image Q, depicted in FIG. 4D, and the lengths and angles are again calculated; by then comparing the lengths and angles of line segments in the master image P and suspect image Q, the factors to be used in the reconstruction can be calculated.

FIG. 4C and FIG. 4D both employ an associated outline to aid in such calculations; however, it will be appreciated by those skilled in the art that such an outline is not required and it is possible to perform the same calculations using the images themselves.

It will also be appreciated by those skilled in the art that numerous other algorithms apart from, or in combination with, a turning point mapping method may also be used for reconstruction 307, for which an outline such as that depicted in FIG. 4B may or may not be required or desired.

While not required in all aspects, where the registered master images are recomposed 205 to a different format or file size, the suspect image is similarly recomposed 307A to a matching format and/or file size as part of the reconstruction algorithm 307.

In the shown embodiment, the processor 110 compares 309 the two images. While not limited thereto, in at least one embodiment, this comparison 309 is done pixel by pixel. While not limited thereto, in at least one embodiment, this comparison 309 comprises a comparison of outlines such as that described above. It will be appreciated by those skilled in the art that numerous other algorithms for comparing two images may also be used. The comparison 309 concludes with a determination, within a pre-set margin of error, whether the suspect image is “genuine”; that is, whether the object depicted in the suspect image is the same as the object depicted in the master image. If the answer is yes, the system grants access to the service at 310; if the answer is no, the system denies access to the service at 320.

In some embodiments, the security may be higher or lower based on the margin of error during comparison 309. For instance, a very low margin of error could be set, which would require a very close recreation of the original photo through use of high-resolution cameras, tripods, precise positioning, and exact lighting. Such a setting would increase the security of the system. Alternatively, a high margin of error could be set, increasing convenience by accepting more imprecise photographs, but correspondingly decreasing security by increasing the risk of accepting a “forged” authentication object. In various embodiments, such margin of error may be set for all or some by the controller of the service, or by each individual user.

In some embodiments, the authentication object may be a digital object—that is, a computer-generated object—or the user may submit the same image file for both the registration and the authentication. In some such embodiments, the margin of error during comparison 309 may be set to zero.

3. Advantages of the Invention

Using image and object authentication, it is possible to make a system that is both very secure and convenient for the user.

While not limited thereto, an advantage of an aspect of the invention is that the increasing ubiquity of smartphones, tablets, and other devices including both cameras and network connection capabilities, allows for convenient creation and submission of images of objects. While not limited thereto, a further advantage of an aspect of the invention is that it can be used as the authentication method to access such devices.

While not limited thereto, an advantage of an aspect of the invention is that an unlimited number of authentication objects are possible, without forcing a user to remember a long list of complicated passwords. A further advantage of an aspect of the invention is that it may be convenient to store tens or even hundreds of unique authentication objects on a user's person or within reach of an imaging device.

While not limited thereto, an advantage of an aspect of the invention is that a provided description, object outline, or combination thereof will help the user remember the authentication object without compromising the security of the system. A further advantage of an aspect of the invention is that writing a description of the authentication object to assist the user's memory does not compromise the security of the system.

While not limited thereto, an advantage of an aspect of the invention is that an image of an authentication object can be consistently reproduced, thus providing stability.

While not limited thereto, an advantage of an aspect of the invention is that the authentication object, when not a body part, can be changed to another object.

While not limited thereto, an advantage of an aspect of the invention is that the user or service controller may customize and manage how convenient or secure the system is. For example, if the user wants a high level of security, he could place the object being used as the password in a safe and delete all saved images of the object. That way, the user would have to physically retrieve the object and take a photo at the time of authentication instead of submitting a saved image file. At the other extreme, the user may create a single image and store it both for registration of the master image and all submissions of suspect comparison images.

4. Types of Authentication Objects

In at least some embodiments, the object being used for authentication can be any physical object that can be photographed. The object should be unchanging so the image can be consistently reproduced. While several example objects and categories of objects follow, it will be appreciated by those skilled in the art that the variety of possible objects is not limited thereto.

In some embodiments of the invention, the system might accept any photographed object for authentication, while in other embodiments, allowed objects might be limited to specific categories of objects, both those described below and others that will also be appreciated by those skilled in the art.

Although not limited thereto, an ideal authentication object will be distinct and rare or unique, to prevent the creation of matching objects by intruders. Although not limited thereto, an ideal authentication object will be of a portable size, to relocate wherever access to the service is desirable. Although not limited thereto, when access to the service is only desired from one location, an ideal authentication object will be located within view of that location.

In some embodiments the object may be three-dimensional, such as personal belongings, specific parts of an object, keys, ornaments, or dolls. While not limited thereto, FIG. 4A depicts one such embodiment in the form of an ornamental magnet. An additional advantage to such an embodiment is that the image of the object may use a variety of angles, increasing security even when the object itself is compromised, as well as allowing multiple unique authentication images based on the same authentication object.

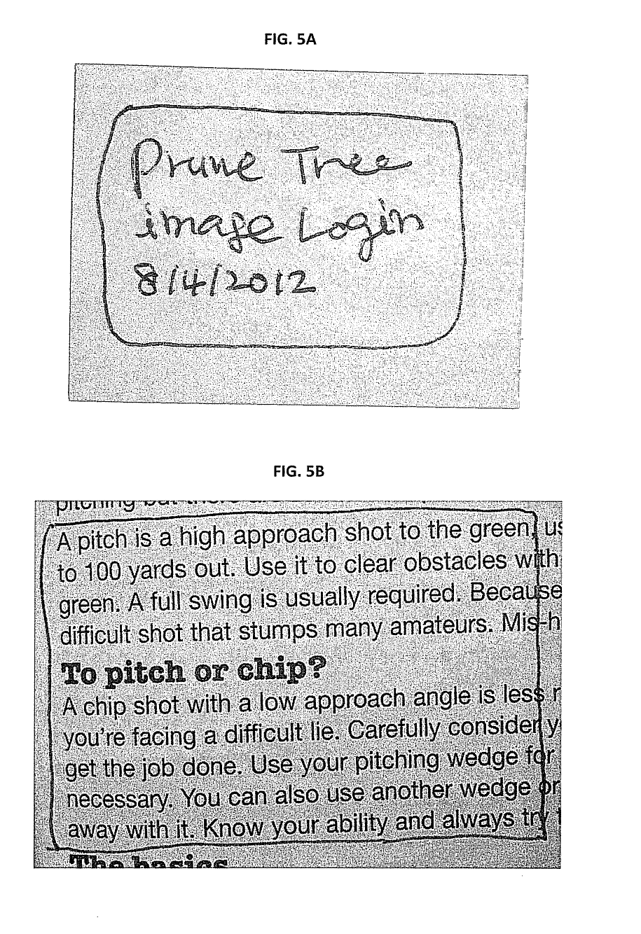

Instead of using an existing object, in some embodiments the user can produce an object himself, such as calligraphy or art. An additional advantage to such an embodiment is that creation of an object digital image via a scanner becomes very convenient. Yet another advantage of such an embodiment is that the user can make an unlimited number of similar unique passwords using his handwriting and art, combined with various writing styles and phrases. While not limited thereto. FIG. 5A depicts one such embodiment in the form of handwritten text and a handwritten semi-rectangular outline on a post-it note. An additional advantage of at least some embodiments, including that in FIG. 5A, is that the papers serving as the surface for the object are easily portable and stored within a wallet or other small container. In at least some embodiments, including that in FIG. 5A, this handwriting is surrounded by an outline, either as an option or as a requirement, to designate the authentication region and assist in reconstruction. As noted above, these outlines may also assist in the reconstruction 307 or comparison 309, although they are not required to do so. Also as noted above, while the outline is solid as shown in FIG. 5A, it is understood that the outline could also be a series of reference points and/or non-linear or curvilinear elements.

Similarly, in some embodiments text or images on a flat surface, such as the page of a book, may be used as the object. Again, an additional advantage to such an embodiment is that creation of an object image via a scanner becomes very convenient. While not limited thereto, FIG. 5B depicts one such embodiment in the form of printed text and a handwritten semi-rectangular outline on a document page. Again, in at least some embodiments, the specific text or images may be surrounded by an outline to designate the authentication region and assist in reconstruction 307 or comparison 309, although they are not required to do so. While not limited thereto. FIG. 5B provides an example of such an outline added by handwriting; in other embodiments, the outline may be part of the printed page. In some embodiments, the text or images may be combined with user-produced content such as handwriting or art, to enhance the uniqueness of the authentication object.

While not depicted, in some embodiments, screen images on a digital device may be used as an object. In some embodiments, such screen images may be reproduced on a convenient device, such as a computer monitor, an eBook reader, a tablet PC, or a smart phone. In some embodiments, an outline is included in the screen image to designate the authentication region and assist in reconstruction. An additional advantage to such an embodiment is that many objects can be stored in a single document file, including but not limited to one to each page; such an embodiment allows convenient storage of several authentication objects.

5. Additional Uses

In another embodiment of the system, image authentication may be combined with other authentication methods including but not limited to conventional passwords, creating a multi-stage authentication process.

In yet another embodiment of the system, another authentication method is used without image authentication as the primary authentication method. However, a master authentication image is also stored during registration. If a password is lost or compromised, image authentication is then used as part of the recovery process. An additional advantage of such an embodiment is that, in the case a service or password is lost or compromised, the users can simply recover and/or change their password by taking and submitting a picture of their image object. If the user does not store a picture of the image object and only takes the photo at the time of authentication, the security of his image password will be very high. A further advantage of such an embodiment is that the ease of such a recovery system will counter the average user's distaste for complex and forgettable but secure passwords.

As already stated, the methods and systems described above are by no means limited to computer services but can cover numerous other “locked” services and objects. One such other embodiment might involve access to a locked smartphone, wherein a user unlocks the phone by pointing the phone's camera at an authentication object and pushing a button. Another such embodiment might involve use of an ATM camera, wherein a user holds an authentication object to the camera and thus be granted access to a bank account. Yet another such embodiment might involve an installed camera outside a secured location, wherein a user unlocks the door by holding an authentication object to the camera.

While not limited thereto, it is understood that aspects of the system and method can be implemented using computer software and/or firmware encoded on one or more computer readable media or other non-transitory media readable by a processor and/or computer and implemented using one or more processors and/or computers.

Although a few embodiments of the present invention have been shown and described, it would be appreciated by those skilled in the art that changes may be made in these embodiments without departing from the principles and spirit of the invention, the scope of which is defined in the claims and their equivalents.

1. A method for authenticating a user of a service, the method comprising:
creating a primary digital image of an authentication object, the object not being a body part of the user;
associating a primary outline that surrounds the authentication object with the primary digital image;
transmitting the primary digital image to the authentication device to serve as a master image;
receiving the primary outline associated with the primary digital image;
displaying the received primary outline to the user;
aligning a secondary outline that surrounds a suspect object with the displayed received primary outline;
after the alignment of the secondary outline with the received primary outline, creating a secondary digital image of the suspect object, the suspect object not being a body part of the user;
transmitting the secondary digital image to the authentication device for comparison with the master image;
when the authentication device determines that the suspect object in the digital image matches the master object in the master image, receiving access to the service; and
when the authentication device determines that the suspect object in the digital image does not match the master object in the master image, being denied access to the service.

2. (canceled)

3. The method of claim 1, further comprising:
creating a third digital image of a second authentication object, the object not being a body part of the user; and
transmitting the third digital image to the authentication device to serve as a replacement of the master image.

4. The method of claim 1, further comprising, prior to transmitting the secondary digital image, associating the secondary outline that surrounds the suspect object with the digital image.

5. (canceled)

6. The method of claim 3, further comprising, prior to transmitting the third digital image, associating an outline that surrounds the second authentication object with the third digital image.

7. (canceled)

8. The method of claim 1, further comprising, after creating the primary digital image of the authentication object, transmitting a text description of the primary digital image to the authentication device.

9. The method of claim 8, further comprising, prior to creating the secondary digital image of the suspect object, receiving the text description.

10. The method of claim 1, wherein one or more of the secondary digital images are created by a digital camera.

11. The method of claim 10, wherein the digital camera is a cell phone camera.

12. The method of claim 10, wherein the digital camera is a web camera.

13. The method of claim 10, wherein the digital camera has a mobile operating system.

14. The method of claim 1, wherein one or more of the secondary digital images are created by a scanner.

15. The method of claim 1, wherein one or more of the objects comprises a physical object.

16. The method of claim 15, wherein one or more of the physical objects comprises a handwritten message.

17. The method of claim 16, wherein one or more of the handwritten messages is surrounded by an outline.

18. The method of claim 15, wherein one or more of the physical objects comprises printed material surrounded by an outline.

19. The method of claim 15, wherein one or more of the physical objects comprises a three-dimensional object.

20. The method of claim 1, wherein one or more of the objects comprises a digital object.

21-25. (canceled)

26. A system for authenticating a user of a service, the system comprising:
i) memory which stores data including digital images and user data;
ii) a processor which
stores a trusted digital image of an object, the object not being a body part of the user, as a master image for an authentic user of the service within the memory,
receives a request by an unauthenticated user to authenticate as said authentic user using a suspect digital image sent from the user, and
associates a first outline with the trusted digital image and a second outline with the suspect digital image, said first outline surrounding the object in said trusted digital image, and said second outline surrounding the object in said suspect digital image; and
iii) a user device which creates the request by the unauthenticated user, and aids the unauthenticated user by displaying the first outline with respect to the second outline so that the unauthenticated user can align the second outline with the first outline,
when the object in the suspect image matches the object in the master image, allowing access to the service as the authentic user, and
when the object in the suspect image does not match the object in the master image, denying access to the service.

27. The system of claim 26, wherein the processor further stores a second trusted digital image of an object, the object not being a body part of the user, as a replacement of the master image for an authentic user of the service within the memory.

28. The system of claim 26, wherein the memory comprises a database storing multiple digital images and user data.

29. The system of claim 26, further comprising a transceiver through which the request by the unauthenticated user is received.

30. (canceled)

31. The system of claim 26, further comprising a digital camera which produces and/or provides the trusted digital image and/or the suspect digital image and provides it to the processor.

32-33. (canceled)

34. The system of claim 31, wherein the digital camera further associates an outline with the trusted digital image and/or the suspect digital image, said outline surrounding the object in said digital image.

35. The system of claim 26, wherein the processor, after receiving the request by the unauthenticated user to authenticate, further
compares the second outline associated with the suspect digital image with an outline associated with the master image; and
reconstructs the suspect digital image such that the outline associated with the suspect digital image is aligned with the outline associated with the master image.

36. The system of claim 26, wherein the processor reconstructs the suspect digital image using a turning point mapping algorithm such that turning points and line segments of the suspect digital image are made to match those of the master image.

37. The system of claim 26, wherein the processor further recomposes one or more features of the trusted digital image and/or the suspect digital image.

38. The system of claim 37, wherein one feature recomposed is a size of the trusted digital image and/or the suspect digital image.

39. The system of claim 26, wherein one or more of the objects comprises a physical object.

40. The system of claim 39, wherein one or more of the physical objects comprises a handwritten message.

41. The system of claim 40, wherein one or more of the handwritten messages is surrounded by an outline.

42. The system of claim 41, wherein one or more of the physical objects comprises printed material surrounded by an outline.

43. The system of claim 39, wherein one or more of the physical objects comprises a three-dimensional object.

44. The system of claim 26, wherein one or more of the objects comprises a digital object.

45. The system of claim 26, wherein the processor further processes the service accessed by the authentic user.

46. The system of claim 29, wherein the transceiver further provides access of the service to the authentic user.

47. A non-transitory computer readable medium encoded with processing instructions for implementing the method of claim 1 using one or more processors.

48. A non-transitory computer readable medium encoded with processing instructions for implementing the method of claim 21 using one or more processors.

49. The method for authenticating a user of a service according to claim 1, wherein the primary outline is not a boundary line of the authentication object shown in the primary digital image, and the secondary outline is not a boundary line of the suspect object shown in the secondary digital image.

50. The system for authenticating a user of a service according to claim 26, wherein the first outline is not a boundary line of the object shown in the trusted digital image, and the second outline is not a boundary line of the object shown in the suspect digital image.
